(19) United States
(12) Patent Application Publication
(10) Pub. No.: US 2010/0037230 A1
(43) Pub. Date: Feb. 11, 2010

(54) METHOD FOR EXECUTING A PROGRAM RELATING TO SEVERAL SERVICES, AND THE CORRESPONDING ELECTRONIC SYSTEM AND DEVICE

(75) Inventors: Olivier Potonniee, Marseille (FR); Eric Deschamps, Marseille (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Meudon (FR)

(21) Appl. No.: 12/528,988

(22) PCT Filed: Mar. 4, 2008
(86) PCT No.: PCT/EP08/52618

§ 371 Date: Aug. 27, 2009

(30) Foreign Application Priority Data
Mar. 7, 2007 (EP) 07300851.8

(51) Int. Cl. G06F 9/46; G06F 15/16; G06F 12/02

(52) U.S. Cl. 718/103; 709/203; 711/170

(57) ABSTRACT

The invention relates to a method for executing at least one program pertaining to at least one service included in a device having at least one memory space intended to be allocated for executing at least one of the services, and at least two access points for accessing services accessible from a network external to the device. The device associates a centralizing service with at least two access points and allocates a memory space to a service for receiving a request to connect to one of the services. The centralizing service is executed, making it possible to await reception of a connection request. In the absence thereof, only the centralizing service has the use of an allocated memory space. The invention also relates to a corresponding electronic device and system.

### TECHNICAL FIELD OF THE INVENTION

The invention concerns, in general terms, a method for executing a program relating to at least one service included within an embedded electronic device.

The invention also relates to an embedded electronic device able to provide one or more services from a communication network external to the embedded electronic device. The embedded electronic device uses the method for executing a program relating to at least one service.

The invention also concerns an electronic system comprising such an embedded electronic device cooperating with a host device.

### PRIOR ART

In the remainder of the present description, the word “service” means a processing of a request.

The expression “embedded electronic device” means, in the present patent document, any electronic device comprising at least one memory and a microprocessor and intended to cooperate with a host device for performing a function on behalf of the host device. The embedded electronic device comprises one or more memories possibly of different types used for executing instructions of a program for processing one or more services.

Typically, the microprocessor, as a processing unit, manages and controls the embedded electronic device, in particular for specific tasks. The latter are among other things suitable for services accessible from a communication network external to the electronic device.

An embedded electronic device of this type may be a portable object (or “token”). The portable object constitutes a medium that may be in various forms, for example a dongle, for example of the USB key type (the acronym for “Universal Serial Bus”), or an SIM card (the acronym for “Subscriber Identity Module”).

Conventionally, the embedded electronic device is intended to cooperate with a host device, in order to be able to at least partly exploit one or more services supported by the embedded electronic device.

Typically, the host device can in particular be a personal computer (or PC), a mobile telephone, a personal digital assistant (PDA) or an embedded electronic device reader communicating for example by radio-frequency waves. The host device is connected to the embedded electronic device. The hose device can be considered in itself as an external communication network vis-à-vis the embedded electronic device. The host device may itself be connected to a global communication network. The embedded electronic device is then connected to the global communication network by means of the host device. By way of example, it may be the internet, as a global communication network. It is clear, however, that the invention is in no way limited to access to the internet.

A server is a computer system providing one or more application services to other computer systems called clients through a communication network. The server awaits a request for connection to an application service hosted by the server.

In the context of the present invention, a client first transmits a connection request particular to each application service that it wishes to have executed.

Next the server receives, by means of a point of access to one of the application services, the request for connection to the application services.

Finally the computer system comprising the access points processes the requests for connection to the associated application services, and executes the required application services.

It is known how to integrate a server within an embedded electronic device.

Such an integration can provide an access point for each specific application service offered by the embedded electronic device. Thus the server reserves an access point, in order to ensure corresponding processing for each of the application services available.

Then each application service goes into a passive state awaiting a corresponding request for connection to the application service emanating from a client.

Memory sources make it possible to save, dynamically, that is to say during the execution of a program, in particular the execution context before the execution of the execution stream associated with each application service required.

However, such a solution has a major drawback consisting of monopolising, for each application service in the phase of awaiting the reception of a request for connection to said service, memory resources.

However, such a monopolisation of memory resources, increasing proportionally with the number of available application services “listening” in parallel, increases the size of the memory space to be provided for the application services accessible.

Such an increase in memory space thus monopolised rapidly causes, in particular when the memory space available within the embedded electronic device (such as a chip card) is limited, an exceeding of the memory capacity available.

The exceeding of the available memory capacity caused is detrimental in particular vis-à-vis a task to be executed especially if no request for connection to one of the application services is received.

### DISCLOSURE OF THE INVENTION

The objective of the present invention is in particular to provide an embedded electronic device and a method for executing at least one program for offering one or more services offered by the embedded device and accessible from a communication network external to the embedded device, while optimising the use of available resources for the processing of corresponding connection requests.

This objective is achieved by means of a method for executing at least one program relating to at least one service included within an embedded electronic device, each service requiring the allocation of a memory space to be executed, the embedded electronic device comprising at least one memory space intended to be allocated for executing at least one of the services, and at least two access points for accessing respectively application services accessible from a communication network external to the embedded electronic device.

According to the invention, the method comprises the following steps: the embedded electronic device associates a centralising service with at least two of the said at least two access points; the embedded electronic device allocates a memory space to a service for the reception of a request for connection to one of the said services; the embedded electronic device executes the centralising service, the execution of the centralising service make it possible to await a reception, by at least one of the access points associated with the centralising service, of at least one connection request dedicated to one of the application services; and, in the absence of reception of a request for connection to a service, the only service having an allocated memory space is a centralising service.

The general principle of the invention is therefore based on the interposition, within the embedded electronic device, of one and the same centralising service between a plurality of points of access to application services and the application services thus concerned, to await a potential reception of one or more requests for connection to one or more services.

It should be noted that a request for connection to a service received may not relate to an application service offered by the embedded electronic device or may relate to an application service that does not exist or no longer exists within the embedded electronic device. The application service for which a connection request has been received no longer exists, for example, following an updating of the application service or services offered by the embedded electronic device.

The centralising service therefore centralises the processing of any request for connection to a service received from the communication network external to the embedded electronic device and associated with a corresponding access point. Thus the invention makes it possible to mobilise, during a phase of awaiting reception of potential requests for connection to one or more services coming from the external network, a memory space in relationship only with the centralising service.

Advantageously, the method comprises the following steps: at least one access point associated with the centralising service receives at least one connection request dedicated to an application service; the centralising service is activated for each connection request received and dedicated to an application service; and the centralising service processes each connection request received and dedicated to an application service.

In this way, it is the centralising service that triggers the processing of a connection request particular to an application service received by one of the access points associated with the centralising service.

According to a preferential embodiment of the invention, the method comprises the following step: the centralising service limits to at most a maximum number of at least one execution stream simultaneously underway, so that the number of application services in the course of execution at a given time is less than or equal to the maximum number of execution streams.

Thus the application service is only executed when the maximum number of execution streams is not exceeded.

In a first particular embodiment of the invention, <claim 4>.

In other words, one or more execution streams are generated, in order to execute potentially all or some of the application services concerned, possibly simultaneously.

According to such a first embodiment, the method comprises the following steps: the embedded electronic device pre-instances at most a maximum number of at least one execution stream simultaneously current, the embedded electronic device allocates an execution stream to each application service for which a connection request has been received, referred to as the connected application service; the embedded electronic device executes the execution stream allocated; the allocated execution stream executes, at least partly, each application service connected.

According to a second particular embodiment of the invention, the method comprises, for each connection request received, the following steps: the centralising service instances an execution stream; the centralising service allocates the instanced execution stream to an application service for which a connection request has been received, referred to as the connected application service; the embedded electronic device executes the execution stream allocated; the allocated execution stream executes, at least partly, the connected application service.

In other words, the centralising service makes it possible, after the reception of each request for connection to an application service associated therewith, subsequent processing by the application service concerned, by pointing to the newly generated execution stream. Thus, apart from the execution stream relating to the centralising service, several execution streams relating to the application services may be simultaneously in the course of execution.

It will be understood firstly that the centralising service can control any connection to be opened, and secondly that an application service connected may close the corresponding open connection. On the other hand, the connected application service controls, alone, the communication stream particular to any exchange following the reception of a request for connection to an application service associated therewith, and, after the execution of the service, may return to the client a corresponding response.

In such a second embodiment, the method comprises the following steps: the centralising service detects the reception of a request for connection to an application service with a higher priority than an application service for which a corresponding execution stream is underway; the centralising service instances a new execution stream; the centralising service allocates the said new execution stream instanced to the connected application service with a higher priority; the centralising service transmits, to a scheduler for application service execution streams of the said embedded electronic device, at least one item of information relating to the order of priority of execution of the execution streams; the scheduler activates the said new execution stream allocated to the connected application service with a higher priority; the scheduler suspends the allocated execution stream executing the application service with a lower priority; the said new execution stream allocated executes the connected application service with a higher priority; the scheduler activates the execution steam allocated to the application service with a lower priority; and the scheduler resumes the execution of the application service with a lower priority at the level where the execution of the application service with a lower priority was suspended.

In other words, once a second application service, with a higher priority than a first application service currently being executed, has been the subject of a connection request, the second application service is executed before returning to the first partially executed application service.

According to a third variant embodiment of the invention, at least one execution stream being allocated to the centralising service, the embedded electronic device executing the execution stream allocated, the method comprises the following steps: the centralising service diverts the execution stream from the centralising service to the application service for which a connection request has been received, referred to as the connected application service; the execution stream executes the connected application service; and the execution stream resumes the execution of the centralising service at the level where the execution of the centralising service was diverted.

In other words, the execution stream of the centralising service may for a short while be allocated to the application service for which a corresponding connection request was received, without requiring the availability of another execution stream.

In a preferential embodiment of the invention, at least one connection request dedicated to an application service that has been received within a predetermined period of time by the said at least two access points associated with the centralising service, the method comprises a step of defining, by means of the centralising service, an instruction for scheduling the processing of the request for connection to application services received.

In other words, the connection requests dedicated to application services received are processed, in a given priority order known solely to the centralising service. To do this, a scheduler interrupts the execution of an application service for the execution of another application service with a higher priority.

In this way, the centralising service can manage the connection opening according to an order of priority fixed between the application services accessible and potentially executable.

The invention also concerns an embedded electronic device. The embedded electronic device comprises at least one program relating to at least one service. Each service requires allocation of a memory space in order to be executed. The embedded electronic device comprises at least one memory space intended to be allocated for executing at least one of the services, and at least two access points for accessing respectively application services accessible from a communication network external to the embedded electronic device.

According to the invention, the embedded electronic device comprises: means of associating a centralising service with the said two of the said at least two access points; means of allocating a memory space to a service on reception of a request for connection to a service, means of executing the centralising service making it possible to await reception, by at least one of the access points associated with the centralising service, of at least one connection request dedicated to one of the application services and, in the absence of reception of a request for connection to a service, the only service having memory space allocated is the centralising service.

An embedded electronic device may for example be a USB key.

Finally, the invention relates to an electronic system comprising a host device, and an embedded electronic device as aforementioned and cooperating with the host device.

The host device may for example be a personal computer and the embedded electronic device may for example be a “dongle” not requiring any specific reader for communicating with the personal computer.

### DESCRIPTION OF THE FIGURES IN THE DRAWINGS

Other characteristics and advantages of the invention will emerge from a reading of the description of a single preferential embodiment of the invention given by way of simple non-limitative indicative example and the accompanying drawings, in which:

FIG. 1 present a simplified block diagram of a particular embodiment of an electronic system according to the invention;

FIG. 2 illustrates a simplified diagram of a particular embodiment of an embedded electronic device included within the electronic system of FIG. 1; and

FIG. 3 presents a simplified flow diagram of a preferential embodiment of a method for executing at least one program relating to at least one service included within the embedded electronic device of FIG. 2.

### DESCRIPTION OF A PARTICULAR EMBODIMENT OF THE INVENTION

The general principle of the invention is therefore based on the use of a centralising service executed within an embedded electronic device and attached at a plurality of access points to application services accessible from the outside world, in order to await the reception of requests for connection of application services associated in this way.

Thus the centralising service is the only active service as long as no request for connection to an associated application service existing within the embedded electronic device has been received.

In other words, the execution stream of the centralising service is the only one to be in the course of execution for awaiting connection requests possibly dedicated to application services available within the embedded electronic device.

It is the centralising service than concentrates the request for connection to one or more of the services received with a view to their common processing. The centralising service intercepts the reception of any request for connection to a service for processing thereof, before being able, where applicable, to connect the access point involved in the reception and the corresponding application service concerned.

Once a request for connection to an application service offered by the embedded electronic device has been processed by the centralising service, any subsequent information transmitted from the client directly accesses, that is to say in a manner transparent vis-à-vis the centralising service, the application service connected. One or more items of information transmitted from the client that previously transmitted the request for connection to the application service connected may constitute a request for execution of the service in question, in order to launch its execution.

Likewise, the execution stream executed for the execution of the application service required may transmit any information directly to the client who requested the connection of the application service concerned. It may be a case of specific information on the application service required indicating, for example, that the request for connection to the application service connected has indeed been received followed if applicable by one or more other items of information indicating in its turn that a corresponding execution request is necessary for executing the application service in question.

Consequently, after the reception of a request for connection to an application service, the access point switches directly, that is to say without passing through the centralising service, any subsequent information either transmitted from the client to the corresponding application service connected or transmitted from the application service connected to the client originating the connection request.

In the remainder of the present description, the case is considered of an electronic system comprising a host device and an embedded electronic device that cooperate in order to offer particular application services by means of a centralising server contained in the embedded device.

It is clear however that the invention applies to other electronic systems. A person skilled in the art can easily pass from the electronic system illustrated to another electronic system while remaining within the scope of the present invention.

It may be a case of an electronic system integrating three electronic devices such as for example a personal computer or PC connected to a personal digital assistant or PDA, as a host device, which accepts a SIM card as defined according to the GSM and/or 3GPP (“Third Generation Partnership Project”) standard, as the embedded electronic device. In such a system, the personal digital assistant exchanges firstly with the personal computer connected to the internet and secondly with the SIM card. The SIM card includes several points of access to services accessible from the network or networks external to the SIM card and associated with a centralising service. An entity that is a member of a network external to the SIM card, such as a portable telephone with which the SIM card cooperates, can, as a distant client, access all the services associated with the centralising service of the SIM card.

It is the centralising service that, within the SIM card, regulates the “traffic” due to the requests for connection to the application services received by the access points associated with the centralising service.

Once an access point associated, via the centralising service, with an application service offered by the SIM card receives any other subsequent information, the access point directs any subsequent information transmitted either from the client to the relevant application service connected, or from the application service connected to the client originating the connection request.

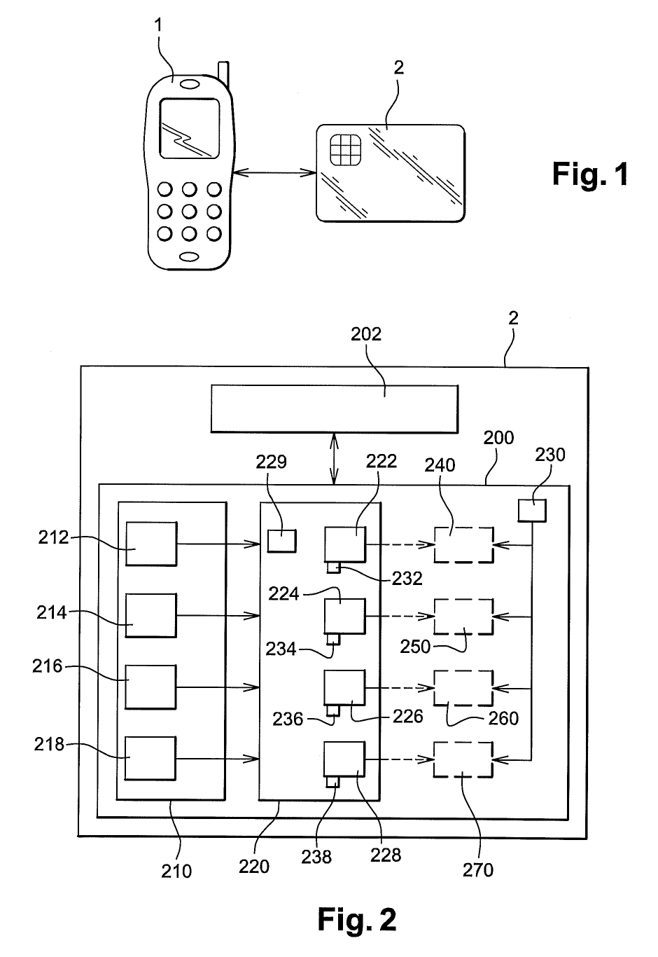

As presented by way of example in relation to FIG. 1, the electronic system comprises a portable telephone 1, as a hose device, connected to a SIM card 2 as defined according to the GSM standard, as the embedded electronic device.

The SIM card 2 is inserted within the portable telephone 1.

The SIM card 2 cooperates with the portable telephone 1 in order to access a communication network external to the SIM card 2, for example through a single physical communication interface.

According to a variant embodiment (not shown), access to the external communication network takes place through several physical communication interfaces.

According to a variant embodiment (not shown), several IP network addresses are associated with the single physical communication interface.

Four access points to application services are associated with the physical communication interface. With each access point there is associated an identifying number of a corresponding application service.

A user benefits from the screen of the portable telephone 1 in order to display icons respectively associated with the application services embedded in the SIM card 2. The user also benefits from the keypad of the portable telephone 1 in order to select an application service to be executed by activating an icon corresponding to the application service by means of one or more buttons on the keypad.

The SIM card 2 is considered as an intelligent device embedding several TCP/IP (the acronyms for “Transmission Control Protocol/Internet Protocol”) application services.

Such TCP/IP application services are software entities that can await execution requests sent by distant clients through a TCP/IP connection previously opened.

Naturally other types of application service or services can be considered, such as one or more UDP/IP (acronyms for “User Datagram Protocol/Internet Protocol”) application services without departing from the scope of the present invention.

The SIM card 2 comprises a server hosting four different particular application services, each associated with one of the four access points to the application services. Each application service can be executed independently of the others after the reception of a request for connection to the application service concerned, possibly followed by an execution request specific to this same application service.

The four access points are preferably associated with a single centralising service.

The SIM card 2 executes the centralising service in order to await any connection requests corresponding to the application services that the SIM card 2 offers outside (via the four access points).

For example, the portable telephone 1, as distant client, sends a connection request, on each of the four access points, to the four application services available within the SIM card 2.

The connections being open, the portable telephone 1 next sends, for each application service then connected so requiring, a request for execution of the corresponding application service.

It is clear that the various requests for connection to application services followed by any request for execution of corresponding services available within the SIM card 2 may come from several distant clients rather than from a single portable telephone 1. It may be a case, as distant client or clients, of another SIM card cooperating with another portable telephone, and/or a personal computer connected to the portable telephone 1.

As application services offered by the SIM card 2, it is possible to cite a web browsing service, a data file transfer service, a service for remote administration of the SIM card 2, for example from a distant server of the OTA (“over the air”) type (not shown) accessible by radio-frequency waves by means of the portable telephone 1, and a service for the secure exchange of data, such as for bank transactions. The web browsing service offered by the SIM card 2 can consist, following a connection request and then a possible request for execution of this service sent by the portable telephone 1 or through the portable telephone 1, of recovering a required index page. In response, the SIM card 2 transmits, to the client originating such request or (consecutive) requests, data particular to the index page required.

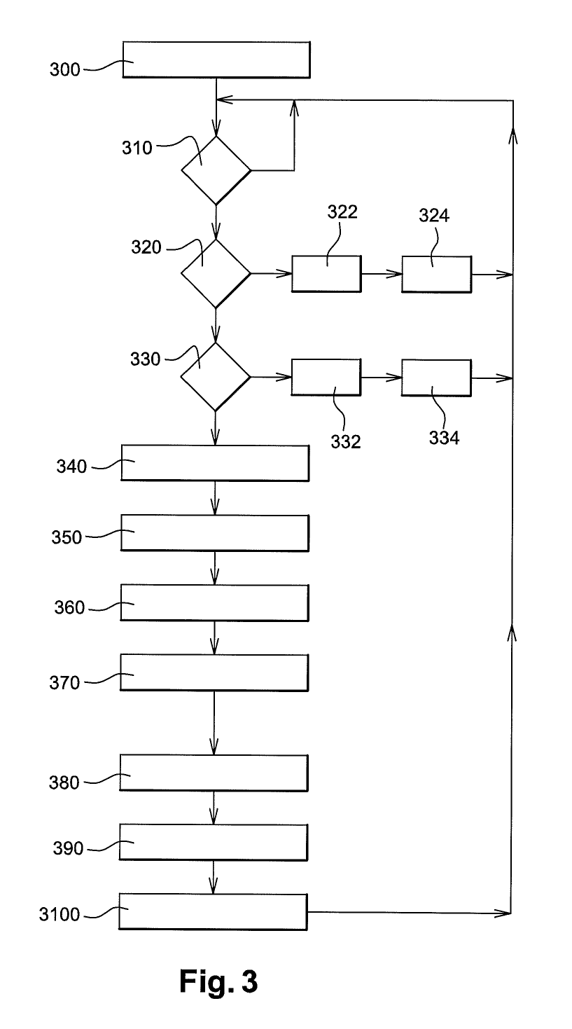

Client/server interactions will be described, in more detail, below in relation to the method described in relation to FIG. 3.

Some of the requests for connection to the application services possibly followed by a corresponding execution request or requests do not necessarily await in return associated responses transmitted from the SIM card 2 to the distant client originating such requests.

This is because it may be a case of a connection request possibly followed by a request for execution of a service particular to the remote administration of the SIM card 2 transmitted from a personal computer (not shown) connected through a communication network to the portable telephone 1. Such an administration execution request is used for example in order to convert, into a predetermined format, with a view to satisfying security constraints, a data file to be transferred from the SIM card to a distant client.

Once a request for connection to an application service has been received by an identified access point corresponding to the service required, and then detected by the centralising service, the execution request of the application service is processed, for reception and execution thereof, by the application service concerned.

To do this, the access point transmits the request for execution of the application service in the direction of the application service in question for execution thereof. When the execution of the application service required is complete, the connection can then be closed by the application service concerned, unless the distant client has to transmit one or more other items of information constituting for example another request for execution of the service connected.

A particular embodiment of the SIM card 2 according to the invention is now described in relation to FIG. 2.

The SIM card 2 comprises in particular a microprocessor 202 and one or more memories allocated for executing several application services and represented in FIG. 2, for reasons of simplification, by a single memory block 200.

It is clear that various separate types of memory are however possible without departing from the scope of the present invention.

The microprocessor 202 drives all the means used by the SIM card 2. The microprocessor 202 manages and controls the internal resources, including the memory block 200, the communications internal to the SIM card 2 and the communications with the outside of the SIM card 2 through an input/output interface (not shown).

The microprocessor 202 also controls the order of scheduling of the execution streams through a scheduler.

The scheduler makes it possible, in particular when several execution streams have to be effected, following the almost simultaneous reception of connection requests associated with one or more application services, to define the order of execution of the corresponding execution streams.

An execution stream is a sequence of instructions able to be executed in parallel with other sequence or sequences either by time slicing or by simultaneous processing by different processors (“multi-processing”).

An execution stream of this type has an entry point, for example by a point referencing the start of the sequence of instructions, and an exit point terminating the sequence of instructions.

In the context of the present description, it is a case of time slicing for the execution of an execution stream executing either the centralising service or an application service at least partly.

However, it is clear that a person skilled in the art can apply the teaching of the invention in a simultaneous processing situation without any particular arrangement.

The scheduler of the operating system of the SIM card 2 may, by means of an interrupt of the hardware type or software type, interrupt an execution stream of a service, consisting either of the centralising service or an application service, in the course of execution. In such a situation, the context of an interrupted execution stream is saved in a dedicated memory area, and a new context is fixed for starting the execution particular to another service. In order to be in a position to resume the execution of the interrupted execution stream, the context of the interrupted and saved execution stream must be restored.

The memory unit 200, as a communication interface with the communication network external to the SIM card 2, comprises 4 distinct memory spaces:
a first memory space 210 associated with a communication service to a network external to the SIM card 2, also referred to as a communication stack to the internet (or “IP stack”),
a second memory space 220 associated with the centralising service,
a third memory space 230 associated with the scheduler, and
a fourth memory space itself to be distributed in four memory spaces 240, 250, 260, 270 respectively associated with the four application services offered by the SIM card 2.

According to a variant embodiment (not shown), several memory spaces are associated for the execution of one and the same application service.

The first memory space 210 comprises four access points to the application services available within the SIM card 2.

The four access points to the application services are associated, logically, with a single physical communication interface, as an input/output interface.

The four access points comprise:
a first access point 212 associated with the number 80 identifying a dedicated service using an HTTP protocol (the acronym for “Hypertext Transfer Protocol”),
a second access point 214 associated with the number 23 identifying a dedicated using a Telnet protocol (the acronym for “TELetype Network”),
a third access point 216 associated with the number 21 identifying a dedicated service using a FTP protocol (the acronym for “File Transfer Protocol”), and
a fourth access point 218 associated with the number 443 identifying a service dedicated to the configuration of the SIM card 2 and using an HTTPS protocol (the acronym for “Hypertext Transfer Protocol Secured”).

Each access point to an application service is able to receive, from an entity external to the SIM card 2, such as the portable telephone 1 or through the latter, coming from another entity to which the portable telephone 1 is connected, a connection request particular to an application service associated with the centralising service.

Each service, constituting either the centralising service or any one of the application services, requires allocation of a memory space in order to be executed.

The centralising service is thus executed and makes it possible to await reception, by each of the four access points 212, 214, 216, 218 associated with the centralising service, of a request for connection to an application service offered by the SIM card 2.

To do this, for example when the SIM card 2 starts up, the centralising service reserves, dynamically, the four access points 212, 214, 216, 218 able to activate it, excluding their association with any other application service. Because of the association of the centralising service with the four access points, direct access to the application services associated with the four access points 212, 214, 216, 218 is prohibited.

A request for connection to an application service, which is received by one of the four access points associated with the centralising service, reawakens the centralising service thus pointed to by such an access reservation. It is the centralising service that processes any connection request received by any one of the four access points 212, 214, 216, 218.

For receiving a request for connection to an application service, the second memory space 220 relating to the centralising service is then the only one to be mobilised as long as no connection request is received by one of the four access points 212, 214, 216, 218 associated with the centralising service.

The centralising service is associated, through a first programming interface of the applications or API (the acronym for “Application Programming Interface”) of the SIM card 2, with each of the four application services accessible from the communication network external to the SIM card 2.

In addition, the centralisation service is associated, through a second API programming interface, with each of the four access points 212, 214, 216, 218 respectively associated with one of the four application services.

The centralising service is responsible either statically, originally, when the SIM card 2 is initialised in the manufacturing factory, or during downloading, for example “OTA” (“Over the Air”), or dynamically, when a supplementary application service or an updating of an application service already present in the SIM card 2 is loaded. With regard to the downloading of another application service to be introduced into the SIM card 2, one of the parameters particular to the existing access point in the SIM card 2 is associated first with the application service in question and then with the centralising service that is to process the reception of a corresponding connection request.

The “C” programming language is, for example, used for the communication service 210. The programming language is preferably an object language, such as Java, for the centralising service 220 and the particular application services, in order to ensure portability for the application services thus offered on different operating systems or OSs.

The SIM card 2 incorporates a memory space allocated for executing each application service.

Only one execution stream of the centralising service is therefore recorded at the operating system of the SIM card 2, in order to manage the reception of connection requests relating to the application services available in the SIM card 2 and received by its access points 212, 214, 216, 218.

Such a centralisation of the processing of the reception of requests for connection to the application services sent from the external network of the SIM card 2 minimises the quantity of memory resources used dynamically within the SIM card 2.

As long as no access point has received a request for execution of an application service supported by the SIM card 2, only one execution stream particular to the centralising service is being executed, rather than one or more of the application services offered by the SIM card 2.

The centralising service 220 is used firstly to make the connection requests of application services received converge, and secondly to distribute, by means of one or more access points associated therewith, any other subsequent items of information, such as requests for execution of the application services thus connected, to the application service or services required.

Thus, when there exists a connection request received by one of the access points associated with the centralising service 220, the centralising service 220 seeks, in a look-up table of associated application services, the corresponding potentially activatible application service.

The centralising service 220 then instances (or creates) an execution stream, in order to be able to execute the application service identified and then connected, by means of parameters corresponding, amongst other things, to the connected application service transmitted by the centralising service 220. While awaiting a potential request to execute the corresponding connected service, no corresponding memory space is mobilised for execution. Such an awaiting of the application service connected therefore leaves no “imprint”.

When a corresponding execution request is actually received, a corresponding execution stream is then activated and processes the execution request. The associated execution stream then executes the required application service.

According to the embodiment shown, the centralising service 220 reserves a memory space 240, 250, 260 and 270 for the execution of an execution stream particular to each application service available within the SIM card 2, for a given session. An arrow starts from each of the memory spaces 222, 224, 226 and 228 associated with the application services within the centralising service 220 and points to a memory space allocated to an execution stream allocated for each application service available. The four arrows pointing to the memory spaces 240, 250, 260 and 270 are shown in dotted lines, to show that such arrows are repositionable. Thus several arrows can start from the same memory space associated, within the centralising service 220, with a first application service and point to several memory spaces allocated to several execution streams allocated to the same first application service.

Once the application service concerned has been executed, the execution memory space particular to the actual execution stream is released, as is the memory space or spaces (not shown) particular to the functions called by the application service. Such memory spaces are then available for a further execution.

To do this, it is once again the centralising service 220 that makes it possible to distribute any other subsequent information, such as one or more new requests for execution of the application service connected.

According to another embodiment (not shown), the centralising service 220 reserves four memory spaces 240, 250, 260 and 270 for execution of an execution stream relating to the execution of only part of the application services available within the SIM card 2, for example for another session. To do this, two, three or four arrows (not shown) can start from the same memory space 222 associated, within the centralising service 220, with a first application service, and point respectively to two, three or four memory spaces where each is allocated to an execution stream allocated solely to the first application service.

The four application services available within the SIM card 2 correspond to the execution of corresponding programs saved in a memory of the ROM type (standing for “Programmable Read Only Memory”) (not shown).

The communication service 210 first checks that:
the sender of a request for connection to an application service offered by the SIM card 2 does actually have access rights, for example in order to protect access vis-à-vis a fraudulent sender; and/or
the addressee corresponds to an application service associated with the centralising service 220 included within the SIM card 2.

On the other hand, it is the centralising service 220 that checks that any request for connection to an associated application service does indeed correspond to an application service offered by the SIM card 2.

The various access points 212, 214, 216, 218 to the application services accessible from the external network, the links of these points to the centralising service and the centralising service 220 are stored, dynamically, in a memory of the RAM type (the acronym for “Random Access Memory”) or of the FRAM type (the acronym for “Ferroelectric Random Access Memory”) or of the MRAM type (the acronym for “Magnetoresistive Random Access Memory”) or of the EEPROM type (the acronym for “Electrically Erasable Programmable Read Only Memory”) or any other equivalent type.

Execution of the execution stream particular to the centralising service 220 takes place, by means of a saving of data particular to the context of the execution stream to be executed, within a memory space, the memory of which is for example of the RAM type. The context includes, in particular, the state of the execution stream of the centralising service, namely for example the awaiting of reception of a request for connection to an application service, the values of registers of the microprocessor 202 before the execution proper of the centralising service and the temporary data to be saved during the execution of the centralising service.

When a request for connection to an application service has been received, the centralising service 220 carries out a search for the service responsible for the processing of the application service required.

What has just been stated, just above, for the execution of the execution stream of the centralising service, is also valid for the execution of an execution stream relating to an application service available within the SIM card 2.

More exactly, the execution of the execution stream particular to one of the four application services is associated with an execution context particular to the execution stream to be executed within a memory space. The memory is also, for example, of the RAM type. The context includes in particular the state of the execution stream of the application service, namely, for example, the values of registers of the microprocessor 202 before the execution proper of the application service concerned and the temporary data to be saved during the execution of the application service.

The server of the SIM card 2 hosts several particular application services, which are accessible only through the centralising service 220.

Each particular application service requires, first of all, a request for connection to the service in question, which is processed by the centralising service 220, and then any execution request transmitted by the distant client through an open TCP/IP connection.

If there does not exist, within the SIM card 2, a service corresponding to the application service that was the subject of a connection request, either no response is sent from the SIM card 2 to the distant client or a simple response indicating by an appropriate message that no corresponding application service exists within the SIM card 2.

If on the contrary there exists an application service corresponding to an application service that was the subject of a connection request, the centralising service 220 creates an execution stream for executing the corresponding application service selected.

The SIM card 2 executes the execution stream of the application service required.

Then the SIM card 2 possibly transmits a response to the distant client who sent the corresponding connection request. Such a response can consist of the transmission of a data file encrypted according to an encrypting algorithm also known to the distant client.

It will be understood that the execution stream particular to a corresponding application service is created only when a request for connection to the service has been first processed by the centralising service 220. Thus each application service available on the SIM card 2 is activated, by means of the centralising service 220, with the request for connection to the corresponding application service as a parameter.

The centralising service 220 comprises, to do this, an identifier of each application service available in the SIM card 2 that it can activate following a link generated dynamically by the centralising service 220. In addition, the centralising service 220 makes it possible to point to the application service that was the subject of a connection request.

The four particular application services are illustrated in dotted lines, in order to indicate that each service is potentially activatible, solely, by means of the centralising service 220, after having received a request for connection to the service in question. Activation of the application service is effected, for some application services, only after having received a corresponding execution request.

In the example described, a service memory space 222, 224, 226, 228 is respectively associated, within the centralising service 220, with each particular application service.

The current number of connections relating to application services managed by means of the centralising service 220 is saved, within a memory space 229 provided for this purpose, as a so-called global counter for the centralising service. The value of the global counter must remain less than or equal to a maximum number of current connections managed by means of the centralising service 220.

Likewise, for each application service managed by the centralising service, the number of current connections for the application service concerned is saved, within an associated memory space 232, 234, 236, 238, as an individual counter of the number of current connections. The value of each individual counter must remain less than or equal to a current execution stream, by default, for the relevant application service managed by means of the centralising service 22.

Thus, for each application service, an individual counter of the number of current connections within a memory space 232, 234, 236 and 238 provided respectively for this purpose. The global counter particular to the centralising service 220 adds the values of individual counters particular to the various application services managed by the centralising service. The value of the global counter must not, for the example chosen, exceed four, while having at most one current execution stream for a given application service.

Optionally, in the same way, a global counter is associated, within a memory space (not shown) provided for this purpose, at the level of the communication service 210 for counting the number of requests for connection to the application services associated with the centralising service. The value of this global counter must remain less than or equal to a maximum number of connection requests received and managed via the centralising service 220. The value of this global counter must not, for the example chosen, exceed four connection requests received.

When a connection request has been received for each of the four application services, the maximum number of current execution streams for the application services associated with the centralising service 220 and the maximum number of connections for each application service have respectively been reached at the global 229 and individual 232, 234, 236, 238 counters.

Because of the current execution of a centralising service 220 in parallel with the four application services, the memory space resulting from a pseudo-simultaneous execution of the four services involved is proportional to five services.

Any other request for connection to an application service that is received and indirectly involves an exceeding of the maximum number of current execution streams is then refused by the centralising service 220.

According to another embodiment, the number of execution streams in the course of execution for a given application service, referred to as the maximum individual number, which has previously been the subject of a corresponding connection request, is greater than one, and for example equal to four.

Thus, according to such an embodiment, the same application service can mobilise all the memory spaces relating to the execution of a current execution stream. When the maximum individual number of current execution streams for the application service in question has been reached, then any other request for connection to the application service that is received and managed by the centralising service is then refused by this same centralising service.

Once the application services have been executed, the memory spaces 240, 250, 260 and 270 associated for the execution of such application services are released.

When a particular supplementary application service (not shown) is to be added, the supplementary application service is first of all loaded or downloaded within the SIM card 2. A corresponding supplementary access point is created, within the service 210 for communication to the network, associating with it a new corresponding service identifier, then the centralising service 220 adds in its look up table, as a “pointer”, such a corresponding service identifier. Thus the SIM card 2 can receive a request for connection to this supplementary service, the centralising service 220 can also await a connection request relating to this supplementary service. When the supplementary access point has received a corresponding connection request, the centralising service 220 then informs the supplementary application service of the switching, by pointing to a corresponding execution stream relating to the particular supplementary application service added. The supplementary application service is executed. Once the supplementary application has been executed, the centralising service 220 can terminate by closing the execution stream of the supplementary service executed, thereby releasing the memory space used for execution thereof.

There is now presented, in relation to FIG. 3, a particular embodiment of the method, according to the invention, for executing at least one program relating to at least one service included within the SIM card 2, as an embedded electronic device.

First of all, during a first step 300, on startup, all the four access points accessible from the external network of the SIM card are associated with a centralising service managed within the SIM card.

To do this, an identifier particular to an application service offered is associated with each access point in an enduring list of the centralising service.

Each application service is thus selectable by a distant client by means of its identifier via the associated access point. Such a selection remains valid even if the SIM card is extracted from the portable telephone with which the SIM car cooperates, because of the existence of the enduring list within the centralising service.

It should be noted that, for reasons of simplification, only one processing chain particular to an access point has more particularly been described below.

During a following step 310, for all the four access points to a respective application service of the SIM card 2, an execution stream dedicated to the centralising service is the only one currently being executed.

The centralising service currently being executed makes it possible to await a connection request sent from a distant client on each of the associated access points.

The distant client belongs to the communication network external to the SIM card 2 and is able to request the execution of an application service.

It will be understood than none of the application services associated with the access points is executed or mobilises a corresponding memory space for the reception of a corresponding connection request.

Thus only the centralising service is executed and mobilises a memory space for the reception of a connection request on one of the access points with which the centralising service has been associated.

As long as a connection request has not been received by a dedicated access point to an application service and associated with the centralising service, then the SIM card 2 remains in the same state, looping back onto the same waiting step 310.

As soon as a connection request has been received by one of the access points associated with the centralising service, then a step 320 of verifying the existence of the service required of the connection made by the communication service is passed to.

If the communication service processes the request for connection to a service the identifier of which corresponds to none of the application service identifiers offered by the SIM card, then the communication service refuses 322 of the connection. The communication service if necessary informs the distant client originating the request for the connection process that no service exists for which it has received a connection request. Then the communication service closes 324 the required connection, before looping back onto the step 310 of awaiting one or more requests for connection to one or more application services.

On the other hand, if the communication service has recognised that the connection request received corresponds to an application service offered by the SIM card and accepts the required connection, then a following step 330 is passed to, for which the centralising service is responsible.

If no connection request dedicated to an application service associated with the centralising service is received, only the centralising service is executed and generates data to be saved within a dynamically allocated memory space. Thus, as long as the SIM card does not receive a request for connection to an application service that it offers to the external network, only the execution stream of the centralising server is currently being executed at a given moment.

After having received a connection request particular to an application service, the centralising service checks 330 the availability of the service required of the connection.

If the application service for which a request for connection has been received is not available, then the centralising service refuses 332 the opening of the connection. To refuse the opening of the connection required, the centralising service can transmit corresponding information to the distant client originating the connection request.

It may be a case for example of the reset message of the TCP/IP protocol. The non-availability of the application service may be due to one or more unsatisfied constraints.

Such constraints consist of a maximum number of connections open simultaneously, as a so-called global threshold value, for the centralising service managing the associated connections and/or as a maximum number of current connections, as a so-called individual threshold value, for the application service concerned. Then, when such constraints have not been satisfied, the centralising service closes 334 the connection, before looping back onto the step 310 of awaiting one or more requests for connection to one or more application services.

Optionally, if the application service is available, that is to say the availability constraint or constraints are effectively satisfied, then the centralising service triggers 340 a time delay. Such a time delay makes it possible to count down a predefined period for the reception of one or more requests for connection to the application services by the associated access points. The centralising service defines an order of scheduling of the processing of the request for connection to application services received, for a defined period before the triggering of the time delay, for all the access points associated therewith. The period is, for example, a few tens of milliseconds according to priorities configured in the SIM card. Such a period can be defined so that the user of the SIM card perceives no slowing down or stopping in the processing of at least one service being executed within the SIM card.

Then a following step is passed to during which the centralising service enables 340 an instancing of a maximum number of streams for execution of application services simultaneously, for example equal to four, apart from the execution stream particular to the centralising service itself. Thus the number of execution streams current at a given moment cannot exceed the maximum value for the execution of the application services.

It should be noted that a number of connection requests greater than one unit for the same application service connected is possible. To do this, for example, a function of re-entrance by a dedicated instruction for protection of each variable to be kept, such as “lock (b)”, is used. Thus several execution streams of one and the same application service connected are simultaneously being executed, while remaining coherent for the value of one or more variables before the execution of another execution stream of this same application service.

Should one connection request for each application service have been successively received in the predefined period of time, the predefined order of scheduling is, in order of decreasing degree of priority of the processing of the four connection requests for the application services offered, as follows:
an application service identified “httpd: 80”, as the highest priority rank,
an application service identified “Telnet: 23”.
an application service identified “ftp: 21”, followed by
an application service identified “https: 443”, as the lowest-priority rank.

As long as the maximum value for the execution stream of current application services has not been reached, the centralising service opens 350 a connection to the application service last requested. In addition, the centralising service increments by one unit the value of the global counter relating to the number of open connections, for all the access points.

Next the centralising service instances 360 an execution stream to the application service that has just been the subject of a connection request. At the same time, the centralising service increments, by one unit, the value of the individual counter relating to the number of current connection requests for the application service in question.

The centralising service transmits to the scheduler the order of priority of execution for the application services associated therewith. The scheduler then establishes an execution strategy, which takes account of such an order of priority of execution to activate or inactivate one or more execution streams. Such an execution strategy results in a distribution by time of execution adapted between all the application services to be executed.

The following scenario controlled by the scheduler is then possible. Part of an execution stream particular to a first current application service is executed. Then part of another execution stream particular to a second application service with a higher priority is in its turn executed, before returning to the execution of another part of the execution stream particular to the first application service. Next the scheduler once again switches to the execution of another part of the execution stream particular to the second application service. The scheduler makes as many switchings as necessary, according for example to the nature of the functions called by each application service being executed, until it has managed the total execution first of all of the execution stream particular to the second application service followed by that of the execution stream particular to the first application service with a lower priority.

Failing this, no order of priority of execution of the application services is indicated to the scheduler and one or more corresponding execution streams are then respectively executed, once again, or executed in the chronological order of arrival of the connection request associated with the application services to be executed.

Optionally, for example when the maximum number of current execution streams for the execution of the application services is reached, the SIM card diverts an execution stream from the centralising service to the application service for which a connection request has been received, so that the diverted execution stream executes the application service without mobilising additional resources in memory. Once the application service has been executed, the SIM card diverts the execution stream allocated from the application service to the centralising service. Thus the centralising service resumes its execution where it left it. The centralising service in this way uses its own execution stream in order to execute an application service. The execution of the application service therefore mobilises at least the memory space or spaces allocated to the execution of the centralising service.

To do this, it may be a case, for programming in object oriented language, of a method call, diverting the execution of the centralising service to the application service required and vice versa.

Then the SIM card executes 370 the execution stream allocated.

According to a variant embodiment (not shown), during a following step, the application service that was the subject of a corresponding request for connection, or application service connected, awaits the reception of a corresponding execution request, for the application services particular to the services of the http, ftp and https type.

It will be recalled that an application service using the “Telnet” protocol does not require a corresponding execution request to be executed. In other words, only a request for connection to the application service using the “Telnet” protocol is necessary for execution thereof.

Next the execution stream last allocated executes 380 the application service connected. The execution of the application service connected then possibly generates a response transmitted to the client that requested it.

Should the centralising service detect the reception of a request for connection to another application service with a higher priority than that for which a corresponding execution stream is current, the scheduler suspends the execution stream allocated executing the lower-priority application service. Another instanced execution stream then executes the higher-priority service connected. As soon as the higher-priority service has been executed, the scheduler resumes control and allows execution of the lower-priority service of the two at the level where the execution of the lower-priority service was suspended.

Once execution of the requested application service has ended, the allocated memory space corresponding to the execution stream allocated is released 390.

Finally, the connection opened via the access point associated with the application service identified is closed 3100, before looping back onto the step 310 of awaiting one or more requests for connection to one or more application services.

The embodiment presented above is not intended to reduce the scope of the invention, and therefore numerous modifications can be made to it without for all that departing from the scope thereof. In a few words, there can be provided, as illustrated in the embodiment that has just been presented, an embedded electronic device in which only the centralising service has memory space allocated for the reception of connection requests for associated services by means of the centralising service.

It is also possible to provide an embedded electronic device in which not only is a centralising service associated with several points of access to services from an external communication network, but also at least one other access point associated with a directly accessible service (that is to say not associated with the centralising service), the centralising service and the directly accessible service having allocated memory space then “double with respect to the embodiment presented” for the reception of incoming connection requests. More exactly, the centralising service mobilises a first memory space allocated for the reception of connection requests associated with the services particular to the access points associated with the centralising service. Likewise, the service directly accessible and associated directly with another access point than those associated with the centralising service mobilises, in parallel, a second memory space allocated for the reception of a corresponding connection request.

1. A method for executing at least one program relating to at least one service included within an embedded electronic device, each service requiring allocation of a memory space for being executed, the embedded electronic device comprising at least one memory space intended to be allocated for executing at least one of the services, and at least two access points for respectively accessing application services accessible from a communication network external to the embedded electronic device,
wherein the method comprises the following steps:
the embedded electronic device associates a centralising service with at least two of the two access points;
the embedded electronic device allocates a memory space to a service for receiving a request for connection to one of the services;
the embedded electronic device executes the centralising service, the execution of the centralising service making it possible to await a reception, by at least one of the access points associated with the centralising service, of at least one connection request dedicated to one of the application services;
and, in the absence of reception of a request for connection to a service, the only service having a memory space allocated is the centralising service.

2. A method according to claim 1, in which the method comprises the following steps:
at least one access point associated with the centralising service receives at least one connection request dedicated to an application service;
the centralising service is activated for each connection request received and dedicated to an application service; and
the centralising service processes each connection request received and dedicated to an application service.

3. A method according to claim 2, in which the method comprises the following step:
the centralising service limits to no more than a maximum number of at least one execution stream simultaneously current,
so that the number of application services being executed at a given time is less than or equal to the maximum number of execution streams.

4. A method according to claim 2, in which the method comprises the following steps:
the embedded electronic device pre-instances no more than a maximum number of at least one execution stream simultaneously current,
the embedded electronic device allocates an execution stream to each application service for which a connection request has been received, referred to as the connected application service;
the embedded electronic device executes the execution stream allocated;
the execution stream allocated executes, at least partly, each application service connected.

5. A method according to claim 4, in which the method comprises the following steps:
the centralising service detects the reception of a request for connection to an application service with a higher priority than an application service for which a corresponding execution stream is current;
the centralising service allocates a new pre-instanced execution stream to the application service with a higher priority connected;
the centralising service transmits, to an execution stream scheduler, at least one item of information relating to the order of priority of execution of the execution streams;
the scheduler activates the new execution stream allocated to the higher-priority application service connected;
the scheduler suspends the execution stream allocated executing the application service with the lower priority;
the new execution stream allocated executes the higher-priority application connected;
the scheduler activates the execution stream allocated to the application stream with a lower priority; and
the scheduler repeats the execution of the application service with the lower priority at the level where the execution of the application service with a lower priority has been suspended.

6. A method according to claim 2, in which the method comprises, for each connection request received, the following steps:
the centralising service instances an execution stream;
the centralising service allocates the execution stream instanced to an application service for which a connection request has been received, referred to as the connected application service;
the embedded electronic device executes the execution stream allocated;
the execution stream allocated at least partly executes the application service connected.

7. A method according to claim 6, in which the method comprises the following steps:
the centralising service detects the reception of a request for connection to an application service with a higher priority than an application service for which the corresponding execution stream is current;
the centralising service instances a new execution stream
the centralising service allocates the new instanced execution stream to the higher-priority application service connected;
the centralising service transmits, to a scheduler of execution streams of application services of said embedded electronic device, at least one item of information relating to the order of priority of execution of the execution streams;
the scheduler activates the new execution stream allocated to the higher-priority application service connected;
the scheduler suspends the allocated execution stream executing the application service with a lower priority;
the new execution stream allocated executes the higher-priority application service connected;
the scheduler activates the execution stream allocated to the application service with a lower priority;
the scheduler repeats the execution of the application service with a low priority at the level where the execution of the application service with a lower priority was suspended.

8. A method according to claim 2, in which, at least one execution stream being allocated to the centralising service, the embedded electronic device executing the execution stream allocated, the method comprises the following steps;
the centralising service diverts the execution stream from the centralising service to the application service for which a connection request has been received, referred to as the connected application service;
the execution stream executes the connected application service; and
the execution stream resumes the execution of the centralising service at the level where the execution of the centralising service was diverted.

9. A method according to claim 3, in which, at least one connection request dedicated to an application service having been received within a predetermined period of time by the access points associated with the centralising service, the method comprises a step of defining, by means of a centralising service, an instruction for sequencing of the processing of the requests for connection to application services received.

10. A method according to claim 1, in which each application service is included within the group comprising:
the services of the “Hypertext Transfer Protocol” type;
the services of the “Hypertext Transfer Protocol Secured” type;
the service of the “Telnet” type;
the services of the “File Transfer Protocol” type.

11. An embedded electronic device, the embedded electronic device comprising at least one program relating to at least one service, each service requiring allocation of a memory space in order to be executed, the embedded electronic device comprising at least one memory space intended to be allocated for executing at least one of the services, and at least two access points for accessing respectively application services accessible from a communication network external to the embedded electronic device,
wherein the embedded electronic device comprises:
means of associating a centralising service with the of the said at least two access points;
means of allocating a memory space to a service on reception of a request for connection to a service,
means of executing the centralising service making it possible to await reception, by at least one of the access points associated with the centralising service, of at least one connection request dedicated to one of the application service,
and in which, in the absence of reception of a request for connection to a service, the only service having a memory space allocated is the centralising service.

12. A device according to claim 11, in which the memory space is included within a memory, the memory being included within the group comprising:
memories of the “Random Access Memory” type;
memories of the “Ferroelectric Random Access Memory” type;
memories of the “Magnetoresistive Random Access Memory” type;
memories of the “Electronically Erasable Programmable Read-Only Memory” type.

13. A device according to claim 11, in which the embedded electronic device is a SIM card as defined in the GSM standard.

14. A device according to claim 11, in which the embedded electronic device is a USB key.

15. An electronic system comprising:
a host device, and
an embedded electronic device communicating data with the host device, the embedded electronic device being the embedded electronic device according to claim 11.

16. A system according to claim 15, in which the host device is a portable telephone.

17. A system according to claim 15, in which the host device is a personal computer.
